(19) United States
(12) Patent Application Publication
(10) Pub. No.: US 2026/0311246 A1
(43) Pub. Date: Oct. 8, 2026

(54) SYSTEMS AND METHODS FOR AUTOMATICALLY DETECTING USE BY MULTIPLE PARTIES OF SAME OR SIMILAR ALGORITHMIC BID ITEM GENERATOR

(71) Applicant: Haul Hub, Inc., Boston, MA (US)

(72) Inventors: Joseph Spinelli, Harvard, MA (US); Corey Paradis, Dover, NH (US); Micah-Shalom Kesselman, Medford, MA (US)

(21) Appl. No.: 19/642,330

(22) Filed: Apr. 8, 2026

Related U.S. Application Data
(60) Provisional application No. 63/785,561, filed on Apr. 8, 2025.

(51) Int. Cl. G06Q 30/08; G06Q 30/0601

(52) U.S. Cl. CPC G06Q 30/08; G06Q 30/0609

(57) ABSTRACT

Systems and methods for certifying and validating bids on construction projects. Digital certification proves that components to a bid (bid items) were generated by software as described in the bid via a reversible transformer and private key-public key architecture. Unintentional collusion is identified by generating derivative bid models of a suspicious bidders using historical and contextual data and then further processing those models.

### CROSS REFERENCE TO RELATED APPLICATIONS

This application claims a benefit of U.S. Provisional Patent Application No. 63/785,561, filed Apr. 8, 2025, titled “SYSTEMS AND METHODS FOR AUTHENTICATING BIDS ON A CONSTRUCTION PROJECT,” the entire contents of which are hereby incorporated by reference herein, for all purposes.

### BACKGROUND

### Field of the Invention

The invention relates to automatically preventing (possibly tacit) algorithmic price fixing and, more specifically, systems and methods for automatically detecting bid items generated by same or similar electronic algorithmic bid item generation systems.

### Related Art

Large construction projects, such as highways, bridges, airports, and buildings, typically involve many parties, each with its own way of representing and storing data related to a project. For example, a state department of transportation (DOT) may use an electronic database to store project plans, identities of assigned employees, and a list of contractors working on each project. Each project may involve many contractors, such as pavers, steel erectors, and construction debris haulers. The contractors typically obtain construction materials, such as ready-mix concrete, aggregates, structural steel beams, hot-mix asphalt (HMA), timber, salt, etc., from suppliers, and sometimes contractors engage subcontractors to perform some tasks and/or to provide or haul some construction materials.

Prior to commencing work on a project, project owners typically solicit bids from potential contractors. Bids typically include several bid items. A bid item specifies a product, material, service, and/or scope of work (collectively “bid component”) within a bid proposal that a contractor proposes to furnish at a set unit or lump sum price. In a bid, each bid item may be associated with or include a bid item number, price, description, quantity, unit of measure, timeline, permitting information, etc., allowing for detailed, accurate, and comparable project cost estimates. Often, bid items refer to “standard bid items” (formally defined, commonly used items, often listed in standard DOT specifications for highway and structure projects), “standardized special bid items” (items proven useful in recent projects that have not yet been fully incorporated into a standard list), or “project special provision bid items” (custom items specific to a single project, defined in the project's special provisions). However, as used herein, the term “bid item” means at least a price and an identification of a bid component.

Especially with DOT-related projects, there is a need to guard against collusion and other similar behaviors creating deleterious market distortions. Such behaviors include (potentially unintentional) conduct, such as in the case of one or more bidders using inherently collusive automation or artificial intelligence (AI) technology that utilizes global data to suggest bid item values, specifically prices, for individual bidders to include in their respective bids. These electronic algorithmic bid item generation systems typically use or are trained with databases or models (collectively “databases”) containing information about subject matter being bid on. For example, road construction algorithmic bid item generation systems'databases may include information about: potential bidders, their sizes, locations and capacities to take on additional work, costs of raw materials and labor, bid histories (including own and competitor price and/or bid histories), and market demand for their services. These systems typically generate bids item values, specifically prices, that are based, at least in part, on historic and/or expected bids by competitors. Typically, algorithmically generated bid item values are calculated to be close to expected bid item values for similar materials and services by competitors, to avoid pricing the bidder out of the market, without “leaving money on the table.” Furthermore, over time, these systems are likely to monotonically increase prices over time, even in the absence of increased costs.

Some contractors operate in-house algorithmic bid item generation systems, and other contractors subscribe to third-party algorithmic bid item generation systems. In either case, if multiple bidders use the same or similar algorithmic bid item generation systems, or different algorithmic bid item generation systems that use or have been trained with same or similar databases, bids generated by these systems are likely to be identical or similar. The algorithmic bid item generation system(s) effectively collude with themselves and typically increase prices over past bids for similar work.

### SUMMARY OF EMBODIMENTS

These activities may be guarded against by requiring algorithmic bid item generation systems to include certain safeguards, such as avoiding using the same or similar algorithms or the same or similar databases when generating bid items for multiple contractors for the same project, or avoiding automatically increasing bid items over past bid items for similar work. A DOT may require that only authorized electronic algorithmic bid item generation systems may be used. However, a technical problem then becomes vetting bid items submitted by contractors, i.e., ensuring the bid items were generated by authorized systems and not, for example, generated by an unauthorized system.

It is with the above considerations in mind that the following disclosure is made. Methods, systems, and implementations of digital certification are described that include incorporating components generated by an authorized algorithmic bidding system (bidding software) with a digital certificate associated with the bidding software in such a way as to create a modified digital certificate. The modified digital certificate is then received and a decoder is applied to it to generate the digital certificate and an indication of the incorporated components, which can be compared against the components generated by the bidding software. Where the decoded incorporated components are outside a range of the components submitted in the bid, users can be provided an indication of the components not being authentically generated by the bidding software.

An embodiment of the present invention provides a system for automatically detecting use by multiple parties of same or similar electronic algorithmic bid item generator. The system includes at least one electronic algorithmic bid item generator and an electronic bid item validator.

The at least one electronic algorithmic bid item generator is configured to automatically receive a request for a bid item. The request identifies a bid component. In response to receipt of the request, the at least one electronic algorithmic bid item generator is configured to automatically generate the bid item. The (generated) bid item includes a price and an identification of the bid component. For each such bid item, the at least one electronic algorithmic bid item generator is configured to automatically generate an associated digital certificate. The at least one electronic algorithmic bid item generator is configured to output the bid item and its associated digital certificate.

The electronic bid item validator is configured to automatically receive, directly and/or indirectly from the authorized electronic algorithmic bid item generator, a plurality of received bid items and their associated digital certificates. For each received bid item, the electronic bid item validator is configured to automatically analyze the digital certificate of the bid item for an indication the bid item does not meet predetermined criteria related to bid item generation. For each received bid item, if the analysis finds the indication, the electronic bid item validator is configured to reject the received bid item. Otherwise, the electronic bid item validator is configured to pass the received bid item.

Optionally, in any embodiment, the at least one electronic algorithmic bid item generator is configured to automatically generate the bid item according to predefined rules and to generate the digital certificate such that the digital certificate indicates that the bid item was generated according to the predefined rules. The indication the bid item does not meet the predetermined criteria comprises lack of the indication that the bid item was generated according to the predefined rules in the digital certificate.

In any embodiment, the predefined rules may be configured to prevent tacit collusion among multiple bidders.

In any embodiment in which the predefined rules are configured to prevent tacit collusion among multiple bidders, the at least one electronic algorithmic bid item generator may be configured to receive the request for the bid item from a bidder, and the predefined rules are configured to prevent the at least one electronic algorithmic bid item generator using bid data aggregated from multiple other bidders.

In any embodiment in which the predefined rules are configured to prevent tacit collusion among multiple bidders, the at least one electronic algorithmic bid item generator may be configured to receive the request for the bid item from a bidder and generate the bid item by utilizing a bidder-specific model associated with the bidder. In such an embodiment, the predefined rules are configured to prevent utilization of the bidder-specific model in generating a bid item for any other bidder.

In any embodiment in which the predefined rules are configured to prevent tacit collusion among multiple bidders, the predefined rules may be configured to prevent the at least one electronic algorithmic bid item generator using competitor bid data in generating the bid item.

In any embodiment in which the at least one electronic algorithmic bid item generator is configured to automatically generate the bid item according to predefined rules, the at least one electronic algorithmic bid item generator may be configured to receive the request for the bid item from a bidder, and the predefined rules may be configured to prevent generating a bid item based on a bid item prediction for another bidder.

In any embodiment, the at least one electronic algorithmic bid item generator may be configured to receive the request for the bid item from a bidder and constrain the bid item price as a function of historic costs of the bidder.

In any embodiment, the at least one electronic algorithmic bid item generator may be configured to: receive the request for the bid item from a bidder; receive at least one bidder-specific cost of the bidder, in association with the request for the bid item; and constrain the bid item price as a function of the at least one bidder-specific cost of the bidder.

In any embodiment, the digital certificate may include provenance information about the bid item, and the indication the bid item does not meet the predetermined criteria comprises the provenance information indicating a predetermined unacceptable provenance.

In any embodiment in which the digital certificate includes provenance information, the unacceptable provenance may include machine-generated and subsequently modified.

In any embodiment in which the digital certificate includes provenance information, the unacceptable provenance may include human-entered.

In any embodiment, the at least one electronic algorithmic bid item generator may be configured to automatically generate the digital certificate such that the digital certificate includes identifications of information and/or methods used by the electronic algorithmic bid generator in generating the bid item. In such an embodiment, the electronic bid item validator may be configured to automatically: identify, among the plurality of received bid items, bid items that identify comparable bid components, thereby identifying a group of comparable bid items; and for each received bid item of each group of comparable bid items, analyze the digital certificate of the bid item, in relation to digital certificates of other bid items of the group of comparable bid items, for the indication the bid item does not meet the predetermined criteria. In such an embodiment, the indication the bid item does not meet the predetermined criteria may include similarity of: (a) the information used by the at least one electronic algorithmic bid generator in generating the bid item to (b) information used by the same or a different electronic algorithmic bid generator in generating another bid item of the group of comparable bid items.

In any embodiment in which the digital certificate includes identifications of information and/or methods used by the electronic algorithmic bid generator in generating the bid item, the similarity may include: a value in the information used by the at least one electronic algorithmic bid generator being within a predetermined range of a value of a comparable value in the information used by the same or a different electronic algorithmic bid generator.

In any embodiment in which the digital certificate includes identifications of information and/or methods used by the electronic algorithmic bid generator in generating the bid item, the similarity may include: (a) identical methods used by the electronic algorithmic bid generator and the same or a different electronic algorithmic bid generator in generating the bid item and (b) a value in the information used by the at least one electronic algorithmic bid generator being within a predetermined range of a value of a comparable value in the information used by the same or a different electronic algorithmic bid generator.

In any embodiment in which the digital certificate includes identifications of information and/or methods used by the electronic algorithmic bid generator in generating the bid item, the digital certificate may include provenance information about the bid item, and the indication the bid item does not meet the predetermined criteria may include the provenance information indicating a predetermined unacceptable provenance.

Yet another embodiment of the present invention provides a system for digitally certifying contributions to a construction project bid. The system includes a project server orchestrating a bidding process for a construction project, a transmitting device having an installed digital certification engine and installed bid generation software, and a validation server communicatively linked to a validation database storing an identifier of a software configured to generate components of a construction project bid, a digital certificate uniquely corresponding to the identifier, and a decoder, the validation server configured to access a modified digital certificate generated by the transmitting device, wherein the digital certification engine generates the modified digital certificate including the digital certificate and a transformation applied to the generated components, the decoder ingests one or more of the modified digital certificate, the identifier, or the generated components and generates an output including an indication whether the components were produced by the software corresponding to the identifier, and the validation server transmits the indication to the project server.

In some examples of the aforementioned digital certification system, wherein the indication includes a binary value, one mode of the binary value affirming the components were produced by the software corresponding to the identifier and the other mode of the binary value denoting the values were not produced by the software corresponding to the identifier.

In some examples of the aforementioned digital certification system, the indication includes a probabilistic value denoting a likelihood of the components having been produced by the software corresponding to the identifier.

In some examples of the aforementioned digital certification system, the indication includes a unitary value denote either the components were produced or the components were not produced by the software corresponding to the identifier.

In some examples of the aforementioned digital certification system, the digital certification engine integrates multiple digital certificates and multiple respective components for multiple software into the modified digital certificate.

In some examples of the aforementioned digital certification system, the digital certification engine generates the modified digital certificate by applying a public-private key-based reversible hash to the generated components.

In some examples of the aforementioned digital certification system, the decoder includes a private key corresponding to the digital certificate and generates the output by combining the public-private key-based reversible hash as applied to the generated components with the private key.

In some examples of the aforementioned digital certification system, the decoder includes a private hash reversal algorithm corresponding to one or more of the digital certificate or the identifier.

In some examples of the aforementioned digital certification system, the decoder is stored at least in part on an additional server and the validation server retrieves the decoder from the additional server.

In some examples of the aforementioned digital certification system, the bid generation software and the digital certification engine are integrated with each other into a single software application.

In some examples of the aforementioned digital certification system, the bid generation software and the digital certification engine are separate software applications, the outputs of which are separably transmitted to one or more of the project server or the validation server.

In an example, a system for detecting collusion in project bidding includes a server communicatively linked to a project coordinator, the project coordinator configured to receive a plurality of bids for a corresponding project and provide the plurality of bids to the server, a bid repository of historical bid data associated with a portion of bidders respectively associated with the plurality of bids, a bidder cost repository of historical cost information associated with the portion of bidders, and a context repository of one or more of historical economic context data or historical environmental data corresponding to shared time windows of the historical bid data, wherein the server includes an initial collusion detector configured to determine a selection of bidders from the plurality of bidders for collusion review, a bidder model generator configured to generate respective regression models of the portion of bidders based on data from one or more of the bid repository, the bidder cost repository, or the context repository, and a collusionary influence detector configured to generate a likelihood of collusionary influence based on the generated regression models, and wherein the server sends the project coordinator a notice when the likelihood of collusionary influence for a corresponding bidder of the portion of bidders exceeds a threshold, the notice comprising an indication of the respective likelihood and an identification of the corresponding bidder.

In some examples of the aforementioned collusion detection system, the server further includes a derivative model generator configured to generate respective derivative models respectively extracted from each generated regression model, wherein the collusionary influence detector generates the likelihood of collusionary influence based on the derivative models.

In some examples of the aforementioned collusion detection system, the server further includes a secondary derivative model generator configured to generate second derivative models respectively from each generated derivative models, wherein the collusionary influence detector generates the likelihood of collusionary influence based on the secondary derivative models.

In some examples of the aforementioned collusion detection system, one or more of the bid repository, the bidder cost repository, or the context repository is stored on one or more additional servers respectively communicatively linked to the server.

In some examples of the aforementioned collusion detection system, the indication of the respective likelihood is a binary value.

In some examples of the aforementioned collusion detection system, the indication of the respective likelihood is a continuous value.

In some examples of the aforementioned collusion detection system, the indication of the respective likelihood is a categorical value.

In some examples of the aforementioned collusion detection system, the server further includes a segmenting module configured to temporally group data from one or more of the bid repository, the bidder cost repository, or the context repository, wherein the bidder model generator is further configured to generate the regression models based on one or more segment regressions associated with a respective bidder of the portion of bidders.

In some examples of the aforementioned collusion detection system, the server is further configured to store a record of the alert in respective individual bidder history records of each corresponding bidder.

In various examples, the aforementioned systems may be implemented as a computer-implemented method across one or more computer processors. In various examples, the aforementioned systems and/or methods may be implemented as instructions encoded on a non-transitory computer readable medium.

### BRIEF DESCRIPTION OF THE DRAWINGS

In order to describe the manner in which the advantages and features of the disclosure can be obtained, a more particular description of the principles briefly described above will be rendered by reference to specific embodiments or examples thereof which are illustrated in the appended drawings. Understanding that these drawings depict only exemplary embodiments of the disclosure, and are not therefore to be considered unduly limiting of its scope, the principles herein are described and explained with additional specificity and detail through the use of the accompanying drawings in which:

FIG. 1 is a block diagram of a computer, according to an embodiment of the present invention.

FIG. 2 is a system diagram of an infrastructure, according to an embodiment of the present invention.

FIG. 3 is a system diagram of a certificate validation architecture, according to an embodiment of the present invention.

FIG. 4 is a sequence diagram depicting operations, according to an embodiment of the present invention.

FIG. 5 is a system diagram of a bidding device, according to an embodiment of the present invention.

FIG. 6 is a system diagram of a validation orchestrator, according to an embodiment of the present invention.

FIG. 7 is a method flowchart of a digital certificate validation method, according to an embodiment of the present invention.

FIG. 8 is a method flowchart of a collusion detection method, according to an embodiment of the present invention.

FIG. 9 is a schematic block diagram of a system for automatically detecting use by multiple parties of same or similar electronic algorithmic bid item generator, according to an embodiment of the present invention.

FIG. 10 is a schematic flow diagram illustrating operation of an electronic algorithmic bid item generator of FIG. 9, according to an embodiment of the present invention.

FIG. 11 is a schematic flow diagram illustrating operation of an electronic bid item validator of FIG. 9, according to an embodiment of the present invention.

### DETAILED DESCRIPTION OF SPECIFIC EMBODIMENTS

As noted, bid items generated by the same or similar algorithmic bid item generation systems, or different algorithmic bid item generation systems that use or have been trained with same or similar databases, are likely to be identical or similar. Such algorithmic bid item generation system(s) effectively collude with themselves and typically increase prices over past bids for similar work.

These activities may be guarded against by requiring algorithmic bid item generation systems to include certain safeguards, such as avoiding using the same or similar algorithms or the same or similar databases when generating bid items for multiple contractors for the same project, or avoiding automatically increasing bid items over past bid items for similar work. A DOT may require that only authorized electronic algorithmic bid item generation systems, i.e., systems that include such safeguards, may be used. However, a technical problem then becomes vetting bid items submitted by contractors, i.e., ensuring the bid items were generated by authorized systems and not, for example, generated by an unauthorized system.

A system for automatically detecting use by multiple parties of the same or similar electronic algorithmic bid item generator(s) solves this technical problem. The problem is roughly analogous to malformed or malicious network packets in a computer network. The disclosed system is roughly analogous to a computer network router or switch that filters malformed or malicious network packets and rejects such packets but passes packets that are properly formed and benign.

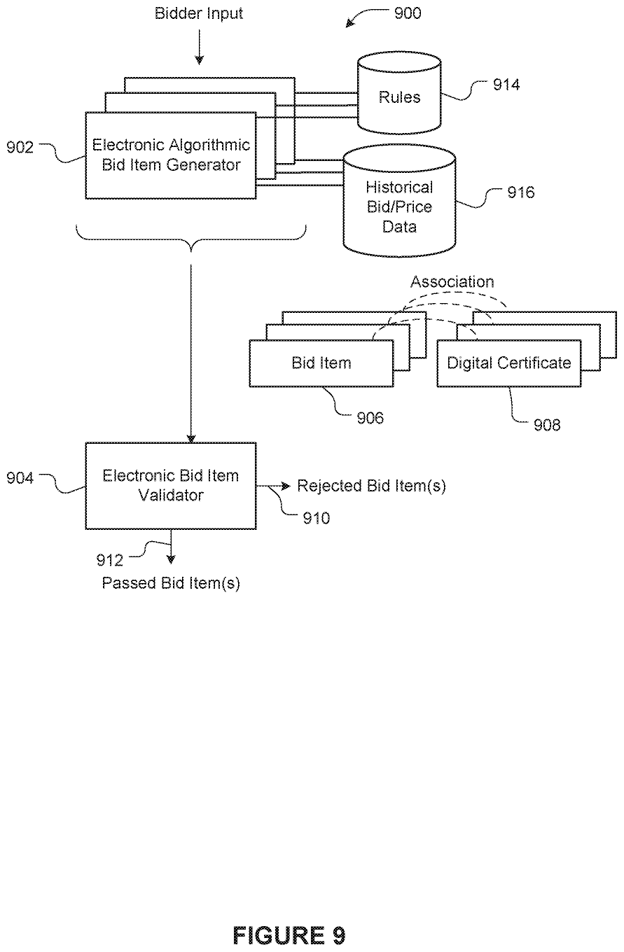

FIG. 9 is a schematic block diagram of a system 900 for automatically detecting use by multiple parties of same or similar electronic algorithmic bid item generator(s), according to one embodiment. The embodiment includes at least one electronic algorithmic bid item generator (represented by bid item generator 902) and an electronic bid item validator 904.

The system 900 vets bid items (represented by bid item 906) generated by the electronic algorithmic bid item generator(s) 902. Authorized electronic algorithmic bid item generators 902 generate and associate a digital certificate (represented by digital certificate 908) with each generated bit item 906.

The electronic bid item validator 904 automatically analyzes the digital certificate 908 of each bid item for an indication the bid item 906 does not meet predetermined criteria related to bid item generation. If the analysis finds the indication, the electronic bid item validator 904 is configured to reject 910 the received bid item 906. Otherwise, the electronic bid item validator 904 is configured to pass 912 the received bid item 906. For example, lack of a proper digital certificate 908 would indicate the bid item 906 does not meet the predetermined criteria. An unauthorized electronic algorithmic bid item generator 902 would not be able to generate a proper digital certificate 908 or perhaps any digital certificate. Consequently, the electronic bid item validator 904 would reject 910 any received bid item 906 that was generated by the unauthorized electronic algorithmic bid item generator 902.

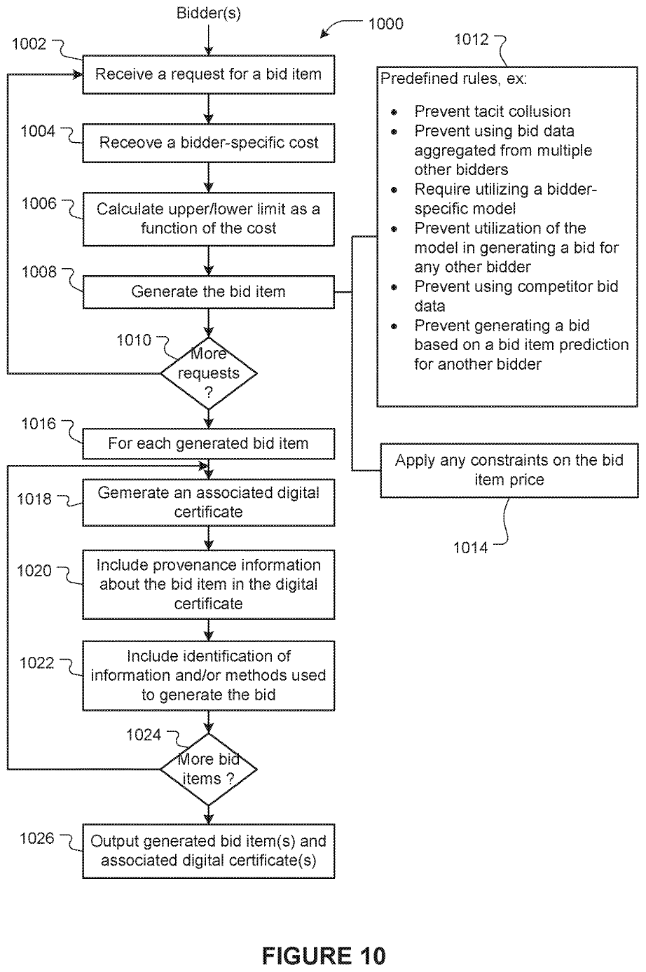

FIG. 10 is a schematic flow diagram illustrating operation 1000 of the electronic algorithmic bid item generator 902 of FIG. 9. At 1002, the electronic algorithmic bid item generator 902 receives a request for a bid item from a bidder. The request identifies a bid component. Optionally, at 1004, the electronic algorithmic bid item generator 902 receives a bidder-specific cost, and at 1006, the electronic algorithmic bid item generator 902 calculates an upper and/or lower limit as a function of the bidder-specific cost. The upper and/or lower limit may be used by the electronic algorithmic bid item generator 902 as a constraint on a value, such as a bid item price, the electronic algorithmic bid item generator 902 generates.

At 1008, the electronic algorithmic bid item generator 902 generates the bid item 906 (FIG. 9). Various known algorithms or future-developed algorithms may be used to calculate values, such as price, for the bid item. The electronic algorithmic bid item generator 902 generates a bid item for each request received at 1002. Consequently, at 1010, if requests remain, control passes back to 1002 to receive and subsequently process each remaining request.

An authorized electronic algorithmic bid item generator 902 (FIG. 9), i.e., a generator that include safeguards, may limit how bid items 906 are generated or limit values of the generated bid items 906. For example, the at least one electronic algorithmic bid item generator 902 may be configured to automatically generate each bid item 906 according to predefined rules 914 (FIG. 9) and to generate the digital certificate 908 associated with the generated bid item 906, such that the digital certificate 908 indicates that the bid item 906 was generated according to the predefined rules 914. Although a shared rule base 914 is shown in FIG. 9, each electronic algorithmic bid item generator 902 may have its own (private) set of rules 914, or any number of electronic algorithmic bid item generators 902 may share a rule base 914. The rules 914 may, but need not necessarily, be different for each electronic algorithmic bid item generator 902.

In some instances, a DOT may specify or approve the rules 914 and then authorize use of a particular electronic algorithmic bid item generator 902 that incorporates those rules 914. The DOT or another authority may then issue a digital certificate for incorporation in the authorized electronic algorithmic bid item generator 902. The authorized electronic algorithmic bid item generator 902 may then use the incorporated digital certificate in generating the digital certificates 908 associated with bid items 906 it generates. The digital certificates 908 generated in association with the generated bid items 906 may be unique to the associated generated bid items 906.

The rules 914 may be configured to prevent tacit collusion 1012 (FIG. 10) among multiple bidders. For example, the predefined rules 914 may be configured to prevent the electronic algorithmic bid item generator 902 using bid data aggregated from multiple other bidders. In another example, the predefined rules 914 may be configured to require the electronic algorithmic bid item generator 902 to generate the bid item 906 by utilizing a bidder-specific model associated with the bidder, and prevent utilization of the bidder-specific model in generating a bid item 906 for any other bidder. In yet another example, the predefined rules 914 are configured to prevent the electronic algorithmic bid item generator 902 using competitor bid data in generating the bid item. In other words, the predefined rules 914 are configured to prevent basing one bidder's bid item 906 on the value of another bidder's bid item 906 value. In a similar vein, in another example, the predefined rules 914 are configured to prevent generating a bid item 906 based on a bid item prediction for another bidder. In other words, the electronic algorithmic bid item generator 902 is prevented from predicting what another bidder's (manually or computer-generated) bid might be and then using that prediction in generating a bid item 906.

The electronic algorithmic bid item generator 902 may be configured to apply one or more constraints 1014 (FIG. 10) on the bid item 906 values it generates. For example, the system 900 may be configured to prevent automatically increasing prices over past bids for similar work by a given bidder and/or by other bidders. For example, the electronic algorithmic bid item generator 902 may be configured to constrain the bid item 906 price as a function of historic costs of the bidder. The electronic algorithmic bid item generator 902 may access historical bid and/or price data 916 stored in a shared or private database to implement such a constraint. For example, the electronic algorithmic bid item generator 902 may be prevented generating a bid item 906 price that is greater than a predetermined inflationary rate of increase over a previous bid item 906 for a comparable bid component, taking into account an amount of time that has elapsed since the previous bid item 906.

As noted, optionally, at 1004, the electronic algorithmic bid item generator 902 receives a bidder-specific cost, and at 1006, the electronic algorithmic bid item generator 902 calculates an upper and/or lower limit as a function of the bidder-specific cost. The electronic algorithmic bid item generator 902 may be configured to constrain the bid item 906 price as a function of the bidder-specific cost of the bidder. For example, the constraint may define an upper and/or lower limit on a value, such as a bid item price, the electronic algorithmic bid item generator 902 generates.

In some embodiments, the system 900 utilizes provenance information about a bid item 906 to vet the bid item 906. The provenance information may indicate the origin and/or post-generation history of the bid item 906. For example, the digital certificate 908 may include provenance information about the bid item, and the indication the bid item 906 does not meet the predetermined criteria may include the provenance information indicating a predetermined unacceptable provenance. For example, the provenance information may include a provenance classification indicating whether the bid item was: (a) machine-generated and unmodified, (b) machine-generated and subsequently modified by a human, or (c) human-entered without use of an electronic algorithmic bid item generator. Examples of unacceptable provenance include “machine-generated and subsequently modified (optionally: by a human)” and “human-entered (optionally: without use of an electronic algorithmic bid item generator).”

For bid items 906 classified as machine-generated and subsequently modified, the digital certificate may further include a modification record that includes the original machine-generated value, the final submitted value, a difference (delta) between the two values, a timestamp of the modification, and an identifier of the modifying actor. Such a modification record enables the electronic bid item validator 904 to assess not only whether a bid item was generated by authorized software, but also whether and how a human intervened after generation.

In some examples, a project owner or regulatory body may configure the electronic bid item validator 904 to treat certain provenance classifications as unacceptable. For example, where a project owner requires bid items to be generated by an authorized electronic algorithmic bid item generator 902 operating under predefined anti-collusion rules 914, the project owner may configure the electronic bid item validator 904 to reject bid items 906 classified as machine-generated and modified. In such configurations, human modification of machine-generated bid items may be treated as unacceptable, because the modification may circumvent or undermine the anti-collusion safeguards enforced by the authorized electronic algorithmic bid item generator 902. For instance, a bidder may use an authorized electronic algorithmic bid item generator 902 to produce a compliant bid item 906 price and then manually adjust the price to coordinate with another bidder, thereby bypassing the guardrails that the authorized electronic algorithmic bid item generator 902 was designed to enforce. Alternatively, a bidder may modify machine-generated prices to obscure the fact that the underlying values were produced by an unauthorized or non-compliant electronic algorithmic bid item generator 902.

In some other configurations, a project owner may configure the electronic bid item validator 904 to reject bid items 906 classified as human-entered. This configuration may be appropriate where the project owner requires all bid items to pass through an authorized electronic algorithmic bid item generator 902, in which case the digital certificate 908 attests to compliance with predefined rules 914. A human-entered bid item 906, by definition, was not processed by an authorized electronic algorithmic bid item generator 902 and, therefore, cannot carry the attestation of compliance that the electronic bid item validator 904 requires.

In still other configurations, a project owner may accept all provenance classifications, but the project owner may weight the collusion analysis differently depending on provenance. For example, convergence of machine-generated and unmodified bid items across multiple bidders for comparable bid components may be treated as a stronger indicator of shared-generator influence than convergence of human-modified bid items, because unmodified items reflect the electronic algorithmic bid item generator 902 output without human intervention and therefore more directly indicate that the electronic algorithmic bid item generators 902 are producing similar or identical results.

The provenance classification and modification record may be incorporated into the digital certificate using the same reversible transformation applied to other bid item components, such that the provenance information is verifiable by the decoder and cannot be altered after generation without detection, as described herein.

Returning to FIG. 10, at 1016, the electronic algorithmic bid item generator 902 processes each generated bid item 906. Optionally, at 1020, the electronic algorithmic bid item generator 902 includes provenance information about the bid item 906 in the digital certificate 908. Optionally, at 1022, the electronic algorithmic bid item generator 902 includes an identification of information and/or methods used to generate the bid item 906 in the digital certificate 908.

At 1024, if more generated bid items 906 remain, control passes back to 1018. At 1026, the electronic algorithmic bid item generator 902 outputs the generated bid item 906 and its associated digital certificate 908. Although the flowchart shows all the bid items being processed before the bid items 906 and digital certificates are output, alternatively each bid item 906 and its associated digital certificate 908 can be output immediately after they have been generated.

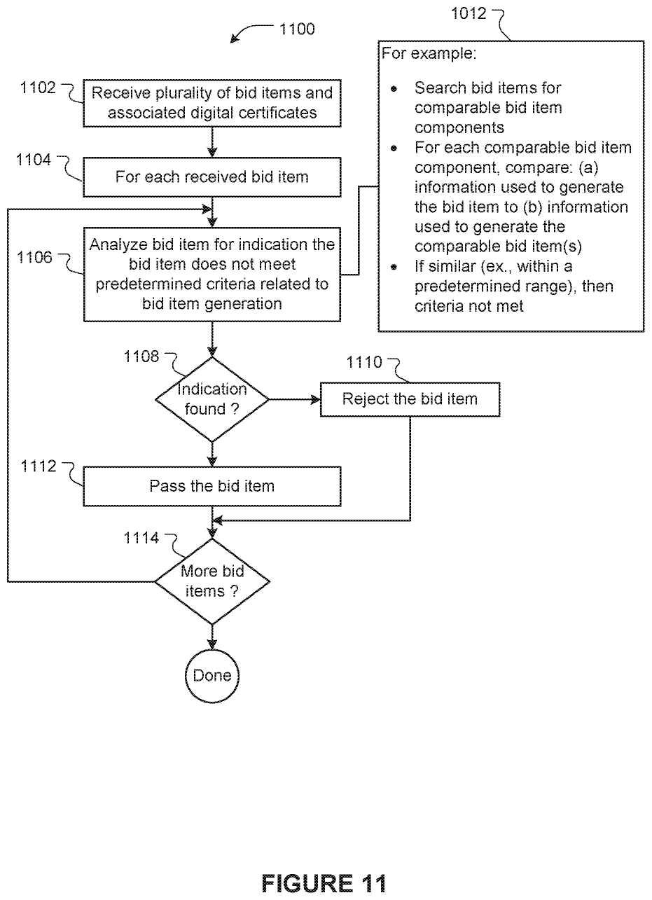

FIG. 11 is a schematic flow diagram illustrating operation 1100 of the electronic bid item validator 904, according to an embodiment. At 1102, the electronic bid item validator 904 receives a plurality of bid items 906 and their associated digital certificates 908 (if any). The electronic bid item validator 904 may receive the bid items 906 and digital certificates 908 directly and/or indirectly from the electronic algorithmic bid item generator 902. That is, the bid items 906 and digital certificates 908 may pass through other electronic and/or non-electronic systems (not shown). At 1104, for each received bid item 906, the electronic bid item validator 904 analyzes 1106 the digital certificate 908 associated with the received bid item 906 for an indication the bid item 906 does not meet the predetermined criteria related to bid item generation. At 1108, if the indication is found, the electronic bid item validator 904 rejects 1110 the bid item, otherwise the bid item 906 is passed 1112. At 1114, if more received bid items remain, control passes to 1106, otherwise the electronic bid item validator 904 is done.

Some of the analysis 1106 performed by the electronic bid item validator 904 is described above and below. For example, in some embodiments, the indication the bid item 906 does not meet the predetermined criteria includes lack, in the digital certificate 908, of the indication that the bid item 906 was generated according to the predefined rules 914. In some embodiments, the predefined rules 914 are configured to prevent utilization of a bidder-specific model in generating a bid item for any other bidder. In these embodiments, if the electronic bid item validator 904 detects a bid item 906 that was generated by a bidder-specific model that is specific to another bidder, the electronic bid item validator 904 rejects the bid item 906.

In another embodiment, if the electronic bid item validator 904 detects a bid item 906 was generated using competitor bid data, the electronic bid item validator 904 rejects the bid item 906. For example, the electronic bid item validator 904 may examine the digital certificate 908 to ascertain what data was used in generating the bid item 906.

In another embodiment, if the electronic bid item validator 904 detects a bid item 906 was generated using a bid item prediction for another bidder, the electronic bid item validator 904 rejects the bid item 906. For example, the electronic bid item validator 904 may examine the digital certificate 908 to ascertain what method was used to generate the bid item 906. If that method includes predicting a competitor's bid item, the received bid item 906 can be rejected 1110.

In another embodiment, the electronic bid item validator 904 analyzes provenance information in the digital certificate 908, as described herein.

In yet another embodiment, the electronic bid item validator 904 identifies, among the plurality of received bid items 906, bid items that identify comparable bid components, thereby identifying a group of comparable bid items 906. The electronic bid item validator 904 rejects the bid item 906 if the electronic bid item validator 904 detects similarity of: (a) the information used by the electronic algorithmic bid generator in generating the bid item and (b) information used by the same or a different electronic algorithmic bid generator in generating another bid item 906 of the group of comparable bid items. In other words, the electronic bid item validator 904 searches the received bid items 906 for comparable bid items 906 that include comparable bid item components. For each found comparable bid item 906, if the information used to generate the bid item 906 is the same or similar to the information used to generate the other bid item 906, the bid item 906 is rejected. Here, “same or similar” can mean within a predetermined range.

In another embodiment, the electronic bid item validator 904 identifies, among the plurality of received bid items 906, bid items that identify comparable bid components, thereby identifying a group of comparable bid items 906. The electronic bid item validator 904 rejects the bid item 906 if the electronic bid item validator 904 detects similarity of: (a) the method used by the electronic algorithmic bid generator in generating the bid item and (b) the method used by the same or a different electronic algorithmic bid generator in generating another bid item 906 of the group of comparable bid items. In other words, the electronic bid item validator 904 searches the received bid items 906 for comparable bid items 906 that include comparable bid item components. For each found comparable bid item 906, if the method used to generate the bid item 906 is the same or similar to the method used to generate the other bid item 906, the bid item 906 is rejected.

Aspects of the disclosure may be supported by various information technology (IT) infrastructures, including either or both local architectures, either as monoliths, networked, or a combination thereof, and hosted architectures, such as a software as a service (SaaS), platform as a service (PaaS), and/or infrastructure as a service (IaaS), or the like. In an example, a supporting infrastructure includes multiple interconnected layers respectively hosting, as an abstraction, various IT processes, services, accounts, and other management components.

The layers of the supporting infrastructure may be divided into, for example and without imputing limitation, an operations layer, a client layer, an infrastructure layer, and an external integrated services layer. Each layer is generally structured around a designated aspect of the IT infrastructure supporting software product offerings, such as the embodiments described in the current disclosure, and is made of various components that each may include any or all of libraries, functions, application programming interfaces (APIs), data stores, and more.

In general, the client layer includes various interfaces through which end users are able to interact with offerings hosted and/or orchestrated by and across the infrastructure layer, either directly or indirectly. As examples, and without imputing undue limitation, mobile applications, web application, installed client binaries, service daemons, system processes, and the like, as well as client-side hardware components may operate principally within the client layer. The infrastructure layer includes various hosted and back-end services, including, for example and without imputing undue limitation, SaaS access points, collection, collation, aggregation, and similar processes, management and orchestration of certain client layer processes and external integrated services layer processes, various other features and processes management functions.

The external integrated services layer is, in some examples and without imputing undue limitation, an abstraction of various third-party services integrated into the IT infrastructure in various ways. For example, and without imputing undue limitation, industry standard security applications, external environment data venders, communications, and other data consumers, producers, and/or third-party integrations may be included in the external integrated services layer. The operations layer generally facilitates various developer, administrator, and support operations for the other layers. In some examples, and without imputing undue limitation, system analytics, logging, monitoring and administrator processes may be executed from the operations layer.

The managed integrations may additionally support a digital certification services module responsible for validating bids by determining whether the bids submitted to projects utilized approved software that supports the bidder side of the bid process, as well as detecting collusive activity across bidders. The bid validation may be accomplished by first associating a public digital certificate with each approved software. The digital certificate may be a unique key which is usable by an encoding program on the bidder's device. In some aspects, the unique key operates as or as part of a reversible hashing algorithm.

The unique key may then be applied to bid components output by its corresponding approved software to generate a modified digital certificate. In some examples, the application of the unique key to the bid components produces an altogether new digital certificate, which is used as the modified digital certificate, that incorporates transformed versions of both the original digital certificate and the components. In other examples, the modified digital certificate may include the original digital certificate and appended bid components transformed by the application of the unique key. In approaches, the resultant modified digital certificate is then sent to the bid receiver as part of the bid submission.

While the digital certificate is public, it is paired with a privately maintained decoder or decoder identifier. The decoder is unique to the digital certificate or corresponding software and is used with the modified digital certificate to confirm the authenticity of the submitted bid components. The modified digital certificate may pass directly from the bidder to a server running a digital certification services module for orchestrating the decoder, or it may be forwarded to the server after being received by the corresponding project owner.

In any case, the decoder extracts the digital certificate and predicted bid component values from the modified digital certificate. At least the predicted bid component values are compared to the values submitted with the bid. In some examples, the original digital certificate may also be extracted from the modified digital certificate, thus providing an additional layer of authentication and security. The extracted components, and digital certificate, are compared to their submitted counterparts to determine whether the submitted ones are correct. An indication of whether they are correct or not is then transmitted to the project owner.

An additional digital certification service that may be provided involves the detection of collusion across multiple bidders. This detection may be accomplished in a two-step process. First, basic collusion is checked for by comparing bidders historical bids, historical costs, and current bids to themselves and to other bidders within the group. The basic collusion detection may be done by fitting a statistical model to each bidder, identifying bidders submitting bids that are anomalous to the model (e.g., are beyond a standard deviation away from their predicted value based on the respectively fit model, etc.), and then comparing identified bidders' bids and histories to each other to identify those displaying similar and/or collusive behaviors.

The second step identifies unintentional collusion, such as due to bidders using the same software or SaaS products. For example, an AI-powered bidding support software may utilize a global model to predict optimal price quotes for various bids. In this context, a global model refers to a probabilistic data structure powering AI-or machine learning (ML)-enabled technologies. In many cases, it will not be practical for a user of such software to execute their own version of the trained global model due to memory and/or computation limitations within their own IT network. As a result, the same trained model may be used by each user of the software by providing inputs to a cloud hosted version of the model. Furthermore, the same model, either as a single instantiation of it or by means of multiple instantiations, may be utilized for multiple or all users of the bidding support software. Such a global model may be prone to converging on an effectively universal pricing, regardless of distinctive factors between users, and especially in cases where the model is further equipped with online (also referred to as real-time or continuous) learning. In this situation, users may end up engaging in collusive pricing unintentionally by virtue of using the same software. For purposes of this disclosure, the above described mode of imputed collusion is referred to as “collusionary” behavior as it is a mode of collusion that is unintentional but nevertheless may be severely detrimental to a market.

The unintentional collusion described above can be checked for in at least two ways. One way of checking is by vetting the software and checking that bids were in fact generated by approved software using the techniques and processes described above. The other way of checking, that may be done instead or in addition to the above way, is to model the bidders'historical bids as respective functions of their historical actual costs and predicted costs. These bidder models may be regression models and each regression may be further segmented by time period, project, or otherwise. A per segment mathematical description may then be generated.

A first order derivative of each segment description can then be calculated, which approximately maps to a mode of change for each segment. These first order derivative segments may then be combined to form a comprehensive mathematical description of change across the entire regression of the respective bidder. The comprehensive mathematical description effectively describes the mode of change across the entire regression. A second order derivative can then be extracted from this comprehensive mathematical description, which effectively describes the mode of change to the mode of change. By this point, most regressions should begin to converge by virtue of similar factors impacting the generation of quotes and thus bids, such as global commodity prices and the like. However, where large differences are observed between bidders, an increased likelihood of unintentional collusion can be inferred. These bidders may be flagged for further analysis to investigate whether unintentional collusion is occurring.

Moreover, any of the steps, operations, processes, executions, and the like described in relation to examples described below can be accomplished by a specific-purpose computer system or general-purpose computer system, and/or enabled by an appropriately configured computer-readable medium and/or data carrier system. The computer system can include a set of software instructions that can be executed to cause the computer system to perform any of the methods or computer-based functions disclosed herein. The computer system may operate as a standalone device or may be connected, for example using a network, to other computer systems or peripheral devices.

Some portions of the description are presented in terms of symbolic representations of operations on non-transient signals stored within a computer memory. These descriptions and representations are used by those skilled in the art to convey the substance of their work most effectively to others. Such operations typically require physical manipulations of physical quantities. Usually, though not necessarily, these quantities take the form of electrical, magnetic, or optical signals capable of being stored, transferred, combined, compared, and otherwise manipulated. It is convenient at times, principally for reasons of common usage, to refer to these signals as bits, values, elements, symbols, characters, terms, numbers, or the like. Furthermore, it is also convenient at times to refer to certain arrangements of steps requiring physical manipulation of physical quantities as modules or code devices, without loss of generality.

All of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (e.g., electronic) quantities within the computer system memories or registers or other such information storage components. Portions of the present disclosure include processes and instructions that may be embodied in software, firmware, or hardware, and when embodied in software, may be downloaded to reside on and be operated from different platforms used by a variety of operating systems.

In a networked deployment, the computer system may operate in the capacity of a server, or as a client user computer in a server-client user network environment, or as a peer computer system in a peer-to-peer or distributed network environment. The computer system can also be implemented as or incorporated into various devices, such as a server or another type of computer such as a workstation that includes a controller, a stationary computer, a mobile computer, a personal computer (PC), a laptop computer, a tablet computer, or any other machine capable of executing a set of software instructions sequentially or non-sequentially that specify actions to be taken by that machine. The computer system can be incorporated as an integrated system part of a larger system that includes additional devices. For example, the computer system can be implemented using one or more electronic devices that provide voice, video, or data communication possibilities. Further, while the computer system is illustrated in the singular, the term “system” may include any collection of systems or sub-systems that individually or jointly execute one or more sets of software instructions to perform one or more computer functions.

The computer system may also include one or more processors. The processor executes instructions to implement some or all aspects of methods and processes described herein. The processor is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a carrier wave or signal or other forms that exist only transitorily in any place at any time. The processor is an article of manufacture and/or a machine component.

The processor is configured to execute software instructions to perform functions as described in the various examples herein. The processor may be a general-purpose processor or may be an application specific integrated circuit (ASIC) in either whole or in part. The processor may also be a microprocessor, a microcomputer, a processor chip, a controller, a microcontroller, a digital signal processor (DSP), a state machine, or a programmable logic device, a logical circuit, including a programmable gate array (PGA), such as a field programmable gate array (FPGA), or another type of circuit that includes discrete gate and/or transistor logic. The processor may be a central processing unit (CPU), a graphics processing unit (GPU), or both. Additionally, any processor described herein may include multiple processors, parallel processors, or both. Multiple processors may be included in, or coupled to, a single device or multiple devices. The processor can include one or more internal levels of cache, and a bus controller or bus interface unit to direct interaction with a bus. The term “processor” as used herein encompasses an electronic component able to execute a program or machine executable instruction. References to a computing device comprising “a processor” should be interpreted to include more than one processor or processing core, as in a multi-core processor. A processor may also refer to a collection of processors within a single computer system or distributed among multiple computer systems. The term computing device should also be interpreted to include a collection, or network, of computing devices each including a processor or processors. Programs have software instructions that can be performed by one or multiple processors that may be within the same computing device or which may be distributed across multiple computing devices. Further, the software instructions, when executed by the processor, perform one or more steps of the methods and processes as described herein.

Turning to further description, reference is made to the drawings of some implementations of the disclosure provided above. It is to be understood that the following disclosure is for explanatory purposes and should not be taken to be unduly limiting. Variations, iterations, and modifications of the described examples are possible while remaining within the scope of the disclosed invention.

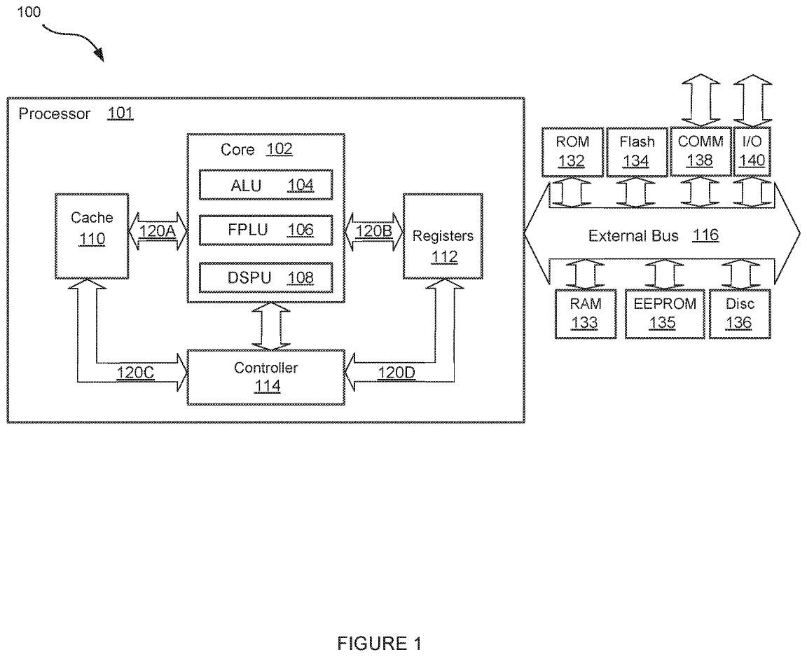

FIG. 1 depicts a block diagram illustrating an exemplary computer system 100 according to examples of the disclosure. Computer system 100 may include a processor 101 for implementing one or more processors described herein. Processor 101 may be any suitable processor type including, but not limited to, a microprocessor, a microcontroller, a digital signal processor (DSP), a field programmable array (FPGA) where the FPGA has been programmed to form a processor, a graphical processing unit (GPU), an application specific circuit (ASIC) where the ASIC has been designed to form a processor, a central processing unit (CPU), or a combination thereof.

Processor 101 may include one or more cores 102. Core 102 may include one or more arithmetic logic units (ALU) 104. In some examples, core 102 may include a floating point logic unit (FPLU) 106 and/or a digital signal processing unit (DSPU) 108 in addition to, or instead of, ALU 104.

Processor 101 may include one or more registers 112 communicatively coupled to core 102. Registers 112 may be implemented using dedicated logic gate circuits (e.g., flip-flops) and/or any memory technology. In some embodiments registers 112 may be implemented using static memory. The register may provide data, instructions and addresses to core 102.

In some examples, processor 101 may include one or more levels of cache memory 110 communicatively coupled to core 102. Cache memory 110 may provide computer-readable instructions to core 102 for execution. Cache memory 110 may provide data for processing by core 102. In some embodiments, the computer-readable instructions may have been provided to cache memory 110 by a local memory, for example, local memory attached to external bus 116. Cache memory 110 may be implemented with any suitable cache memory type, for example, metal-oxide semiconductor (MOS) memory such as static random access memory (SRAM), dynamic random access memory (DRAM), and/or any other suitable memory technology.

Processor 101 may include a controller 114, which may control input to processor 101 from other processors and/or components included in a system and/or outputs from processor 101 to other processors and/or components included in the system. Controller 114 may control the data paths in ALU 104, FPLU 106, and/or DSPU 108. Controller 114 may be implemented as one or more state machines, data paths, and/or dedicated control logic. The gates of controller 114 may be implemented as standalone gates, FPGA, ASIC or any other suitable technology.

Registers 112 and cache memory 110 may communicate with controller 114 and core 102 via internal connections 120A, 120B, 120C, and 120D. Internal connections may be implemented as a bus, multiplexor, crossbar switch, and/or any other suitable connection technology.

Inputs and outputs for processor 101 may be provided via a bus 116, which may include one or more conductive lines. Bus 116 may be communicatively coupled to one or more components of processor 101, for example controller 114, cache memory 110, and/or register 112. Bus 116 may be coupled to one or more components of the system.

Bus 116 may be coupled to one or more external memories. The external memories may include read only memory (ROM) 132. ROM 132 may be a masked ROM electronically programmable read only memory (EPROM), or any other suitable technology. The external memory may include random access memory (RAM) 133. RAM 133 may be a static RAM, battery backed up static RAM, Dynamic RAM (DRAM), or any other suitable technology. The external memory may include Electrically Erasable Programmable Read Only Memory (EEPROM) 135. The external memory may include Flash memory 134. The External memory may include a magnetic storage device such as disc 136. In some examples, the external memories may be included in a system.

In some examples, bus 116 may include a communications interface 138 by way of which computer system 100 can connect to networks and receive data useful in executing the methods and system set out herein as well as transmitting information to other devices. Computer system 100 may further include an input/output (IO) interface 140 for communicatively accessing connected devices. The connected devices may include a video display unit such as a liquid crystal display (LCD), an organic light emitting diode (OLED) display, a flat panel display, a solid-state display, or a cathode ray tube (CRT), and/or any other suitable technology. The connected devices may further include input devices such as a keyboard/virtual keyboard, touch-sensitive input screen, speech input with speech recognition, and/or a cursor control device such as a mouse or touch-sensitive input screen or pad, and/or other suitable technologies. The connected devices may also optionally include a disk drive unit, a signal generation device such as a speaker or remote control, an external network interface device, and/or other suitable technologies.

The processes and displays presented herein are not inherently related to any particular computer or other apparatus. Various general-purpose systems may also be used with programs in accordance with the teachings herein, or it may prove convenient to construct more specialized apparatus to perform one or more method steps. The structure for a variety of these systems is discussed in the description below. In addition, any programming language that is sufficient for achieving the techniques and implementations of the present disclosure may be used. In addition, the language used in the specification has been principally selected for readability and instructional purposes and may not have been selected to delineate or circumscribe the disclosed subject matter. Accordingly, the present disclosure is intended to be illustrative, and not limiting, of the scope of the concepts discussed herein.

In accordance with various embodiments of the present disclosure, the methods described herein may be implemented using a hardware computer system that executes software programs. Further, exemplary implementations can include distributed processing, component/object distributed processing, and parallel processing. Virtual computer system processing may implement one or more of the methods or functionalities as described herein, and a processor described herein may be used to support a virtual processing environment.

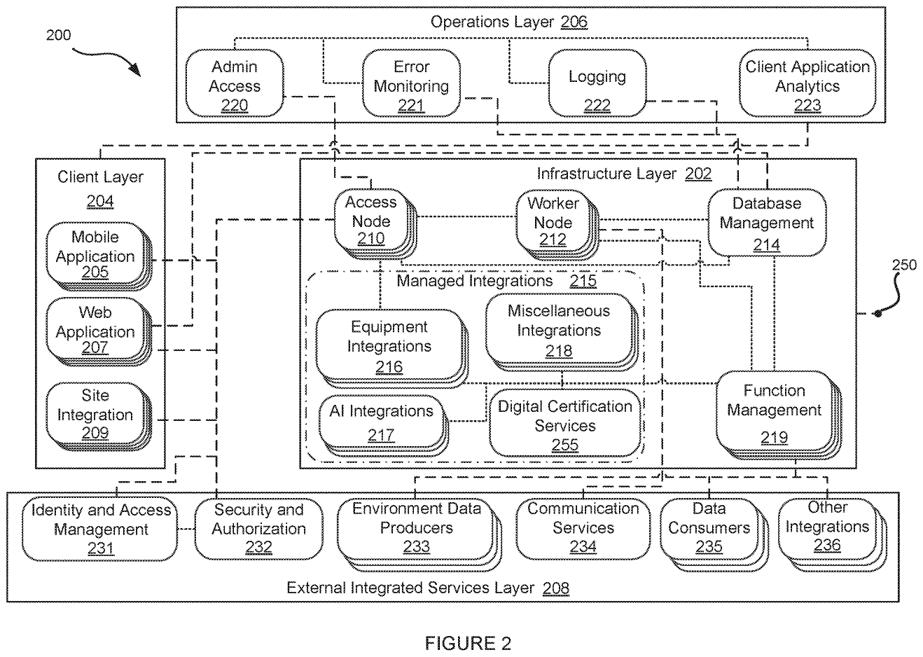

FIG. 2 depicts a supporting infrastructure 200 in diagrammatic form according to examples of the disclosure. Supporting infrastructure 200 may include an operations layer (OL) 206, a client layer (CL) 204, an external integrated services layer (EISL) 208, and an infrastructure layer (IL) 202. It is to be understood that the layers depict logical abstractions and do not necessarily coincide with, for example, shared physical locations for component execution or offering. Rather, the layers of supporting infrastructure 200 group infrastructure components by purpose and the types of access to infrastructure components correspondent to the respective layer. CL 204 generally includes the modes by which end users engage with products and services hosted by supporting infrastructure 200 while IL 202 generally includes the primary functions and operations underpinning those hosted products and services. EISL 208 generally includes external services and integrations which either support IL 202 operations or consume data from IL 202 operations.

CL 204 may include one or more installed applications 205, one or more web applications 207, and one or more site integrations 209. Installed applications 205 include, for example and without imputing undue limitation, software installed to a computing device or computer, including in some examples personal computers, laptop computer, wearables, and mobile devices, such as smart phones, tablets, and the like. Web applications 207 includes software primarily accessed through an internet browser application, which may be executed in whole or in part on either or both a local computer and a hosted computer. Site integrations 209 may include automations integrated into a location's own IT infrastructure and may also include direct or indirect integrations of on-site hardware, such as through on-device installations or via middleware installed into the location's IT infrastructure. The automations and integrations of site integrations 209 enable data flows between IL 202 and the respective site.

Each component of CL 204 (e.g., installed applications 205, web applications 207, site integrations 209, etc.) interfaces with IL 202 via an access node 210. Access node 210 is a scalable hosted process extended as a public IP endpoint. Access node 210 may serve as the target entry point for all end users attempting to interface with IL 202. For example, access node 210 can be addressable via internet protocol (IP) address over the internet. In some examples, access node 210 enforces a format requirement upon received data before further dispatching appropriate services and/or functions within IL 202. The format may be a JavaScript Object Notation (JSON) data object with predefined fields including, for example, authentication and account identification fields, contents fields, and validation fields. Based on the components of the JSON authentication and account identification fields (e.g., prefixed information, suffixed information, flags, etc.), access node 210 may determine which content format to expect and to which IL 202 components to dispatch the incoming data. For example, digital ticket data may include a corresponding flag in its authentication and account identification field and, as a result, access node 210 may check to see whether the corresponding JSON includes an indicator of what type of digital ticket implementation to expect and which fields and in what format those fields can be expected (e.g., a predefined particular vendor format, a site specific format, a generic format, etc.).

IL 202 includes various orchestration and operational processes, in addition to access node 210 as described above, which enable various features made available to users. Based on the received data, access node 210 may deploy or invoke an appropriate worker node 212. Multiple worker nodes 212 may be instantiated by the same access node 210 or other access nodes 210 and each of these additional worker nodes 212 may perform the same or different operations. Worker node 212 is a generalized function or process that may be executed within IL 202 (e.g., by or on a server to which at least some portion of IL 202 is deployed) to perform various features provided to users either via client layer 204 or otherwise, and the specific operations and interactions performed by worker node 212 is determined by data received by corresponding access node 210. In general, worker node 212 will invoke one or more of function management 219, database management 214, and/or communications services 234. Here, communications services 234 is an integrated external service in EISL 208; however, in other examples, communications services 234 may be wholly or entirely a native service run in IL 202 generally or among managed integrations 215. Function management 219 is a generalized function or process that may be executed within IL 202 to perform various processes as needed by worker node 212, including for example interfacing with database management 214, managed integrations 215, and/or EISL 208. Managed integrations 215 may include equipment integrations 216, AI integrations 217, and miscellaneous integrations 218, which are included to represent the general extensibility of the architecture of IL 202. Among managed integrations 215, equipment integrations 216 may also directly interface with access node 210 in order to, for example, perform automated database operations via a corresponding worker node 212 interfacing with database management 214, such as in the case of automated tracking of equipment of on a job site.

EISL 208 is an abstraction of services and processes that support or are supported by processes and functions otherwise executed by IL 202. The services and processes within EISL 208 include infrastructure operations, such as identity and access management (IAM) 231 and security and authorization (SaA) 232, which respectively facilitate user login and manage user access to various services and processes enabled by supporting infrastructure 200. While IAM 231 and SaA 232 are depicted in FIG. 2 as communicating between each other directly, it is understood that other configurations not depicted here are nonetheless disclosed, such as managing correspondence of IAM 231 and SaA 232 via IL 202 or CL 204, or as a merged monolith service, as two non-limiting examples. In some examples, IAM 231 and SaA 232 interface with both CL 204 components and respective access nodes 210 to ensure secure and authenticated interaction between CL 204 and IL 202. Other infrastructure operations that may be included within EISL 208 include communication services 234, which may include email, text messaging, phone call, voice over IP (VOIP), and other human interpretable communications and/or alerts.

EISL 208 may additionally include environment data producers (EDPs) 233 and data consumers 235. EDPs 233 includes a broad range of external services such as mapping, weather, Light Detection and Ranging (LIDAR), vehicle, and other services producing data that may be integrated into a project management system. Accordingly, individual EDPs 233 may require unique or customized integrations, which may be managed and executed function management 219. Data consumers 235 also encompasses a broad range of services such as traffic management, mapping, various regulatory oversight, and other services that may consume data produced by IL 202 for respective purposes. Likewise, individual data consumers 235 may require unique or customized formats and/or protocols, which may be managed and executed by function management 219. EISL 208 further includes other integrations 236, which is abstracts the extensibility of EISL 208 and may be managed on IL 202 through function management 219 accordingly.

OL 206 represents the developer and IT operations features for interfacing and modifying various aspects of supporting infrastructure 200 across each of IL 202, CL 204, and in some examples EISL 208. Generally, OL 206 is not accessible by external users, such as customers utilizing components of CL 204. Admin access 220 encompasses an access profile to IL 202 that allows a user to view and/or modify records associated with end users (e.g., those interfacing with IL 202 primarily through CL 204), such as individual project files and the like. In some examples, admin access 220 undergoes a separate identification, authorization, and security process than those provided by IAM 231 and SaA 232. Error monitoring 221 interfaces with database management 214 and identifies errors that arise in either IL 202 operations or CL 204 operations, such as erroneous project changes or issues with an interface component of an installed application 205. Error monitoring 221 may maintain an error log for later review or may, in some examples, generate an alert. In some examples, logging 222 may include the error among its other functions. Logging 222 may further include activity and process logging. Error logging 222 performs activity and process logging by maintaining a database or other record of activities performed by IL 202, such as database read and write operations, retrievals of external data, user log-ins, and the like. Client application analytics 223 monitors and maintains a record of statistical information on CL 204, such as number of application downloads, account creations, download locations, and the like. In some examples, client application analytics 223 may further include maintaining a record of user interactions at CL 204, such as mouse movements, screen changes, etc. Admin access 220, error monitoring 221, logging 222, and client applications analytics 223 all directly intercommunicate, and in some examples the latter three components of OL 206 may only be accessed and their corresponding records viewed through admin access 220.

Here, digital certification services 255 are further orchestrated by managed integrations 218 and may be dispatched by function management 219. In some examples, access node 210 may receive a corresponding request for digital certification and/or collusion inspection processing. In response, access node 210 may activate worker node 212 to instantiate the corresponding activity, which in turn triggers function management 219 to orchestrate digital certification services 255 as requested. Outputs from digital certification services 255 may then be transmitted to the requestor by function management 219 via communication services 234 and/or recorded into updated databases via database management 214.

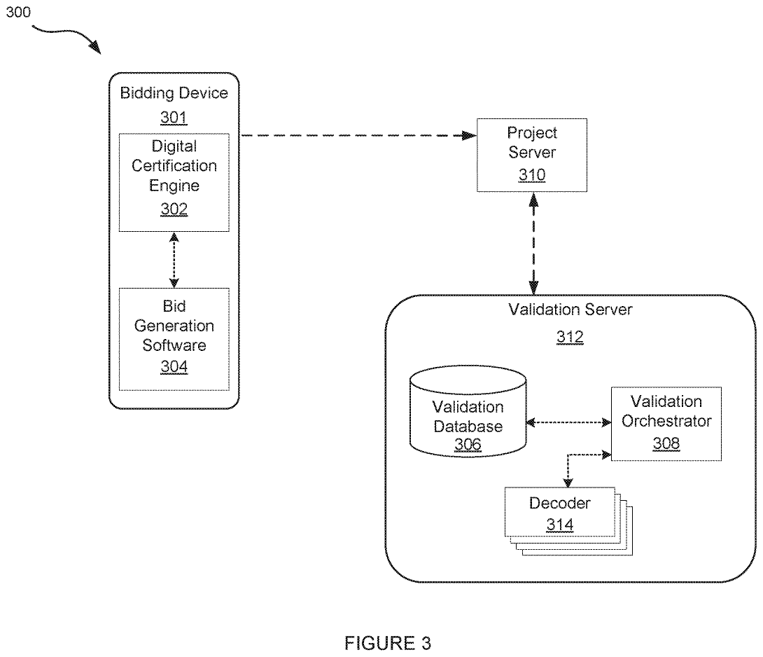

FIG. 3 is an alternative system diagram construction depicting a digital certification architecture 300. Notably, and without imputing undue limitation, digital certification architecture 300 may be mapped to components of supporting infrastructure 200 as described above.

A bidding device 301 includes a digital certification engine 302 and bid generation software 304. While digital certification engine 302 and bid generation software 304 are depicted separately here, it is understood that this an abstraction for visual convenience and, in some examples, digital certification engine 302 may be directly integrated into bid generation software 304. In any case, bid generation software 304 may generate bid components which are processed by digital certification engine 302 in combination with a digital certificate associated with bid generation software 304 that is unique to the particular software package to generate a modified digital certificate. In some examples, the digital certificate may be unique to the installation or license of the particular software package.

The modified digital certificate is distinct from the digital certificate and bid components and incorporates both into a reversible sequence of values. In some examples, the modified digital certificate is not recognizable as either the digital certificate or bid components without the aid of a paired decoder stored separately from digital certification engine 302.

The modified digital certificate is transmitted to a project server 310. Project server 310 may be, for example, a DOT project management server responsible for intaking bids for multiple different ongoing projects at once. In this example, project server 310 forwards the modified digital certificate, the digital certificate, and the bid components to a validation server 312. In some examples, validation server 312 may receive data directly from bidding device 301 before forwarding a validated package on to project server 310.

Validation server 312 includes a validation database 306, a validation orchestrator 308, and a decoder 314. While FIG. 3 depicts decoder 314 as separate from validation database 306, some examples may store decoder 314 directly in validation database 306. Validation orchestrator 308 performs the primary executions and invokes various processes to reverse the modified digital certificate. The received digital certificate is used to query the appropriate decoder 314 from validation database 306, which may return both algorithms and/or formulae to convert the modified digital certificate back into the digital certificate and bid components. Once the conversion is performed, the yielded digital certificate is compared against the received digital certificate to confirm successful backwards conversion and the yielded bid components are compared against the submitted bid components to determine whether the submitted bid components were in truth generated by the bid software.

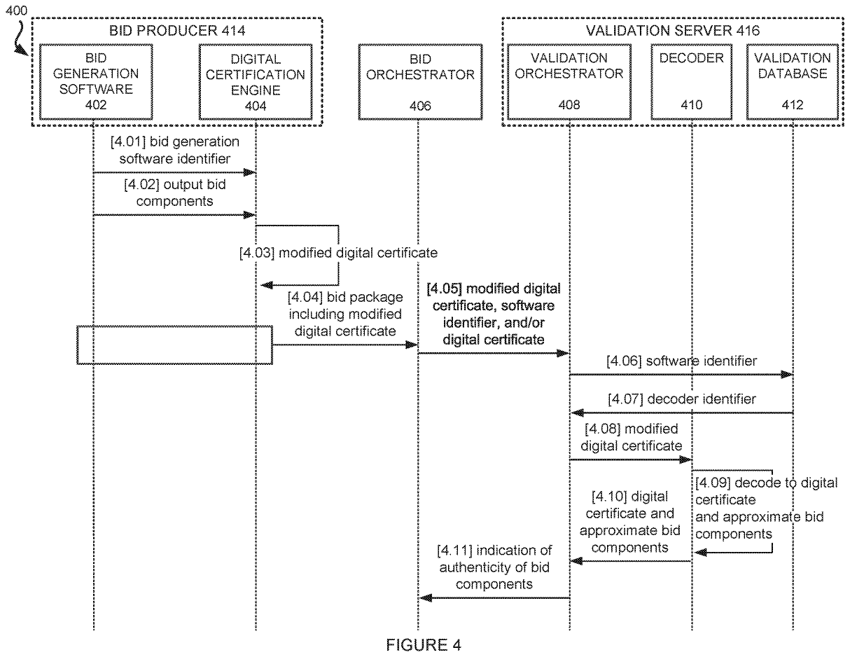

FIG. 4 depicts a sequence diagram 400 further detailing the processing performed by a digital certification system. Bid generation software 402 and digital certification engine 404 are installed on a bid producer 414, which includes a computing device such as, for example, a PC, tablet, mobile device, etc. A bid orchestrator 406 manages the bid validation process and may be, for example, installed on a project management server. Validation is handled by validation server 416, which may be separate from or shared by bid orchestrator 406, and includes validation orchestrator 408 for managing processes, data retrieval, alerting, and more.

Bid generation software 402 transmits a [4.01] bid generation software identifier and a [4.02] output bid components to digital certification engine 404. Digital certification engine 404 generates a [4.03] modified digital certificate from [4.01] and [4.02]. Bid producer 414, either by operations performed by bid generation software 402, digital certification engine 404, or a combination thereof, transmits a [4.04] bid package including a modified digital certificate to bid orchestrator 406.

Bid orchestrator 406 then transmits [4.05] modified digital certificate, software identifier, and/or digital certificate to validation orchestrator 408.

In this example, validation orchestrator 408 transmits [4.06] software identifier to validation database 412, which in response transmits a [4.07] decoder identifier to validation orchestrator 408. Using [4.07] decoder identifier, validation orchestrator is then able to transmit modified digital certificate to decoder 410. Decoder 410 then performs a [4.09] decode of the modified digital certificate to a digital certificate and approximate bid components. In some examples, approximated bid components are used rather than precise bid components to, for example, determine whether the bid components and the approximated bid components are close enough to each other to validate the bid components.

Decoder 410 transmits the decoded [4.10] digital certificate and approximate bid components to validation orchestrator 408. Validation orchestrator 408 performs a comparison of the decoded data against the data provided by bid producer 414 to determine whether the digital certificate was properly decoded and the authenticity of the bid components. As a result, validation orchestrator 408 then transmits an [4.11] indication of authenticity of the bid components to bid orchestrator 406.

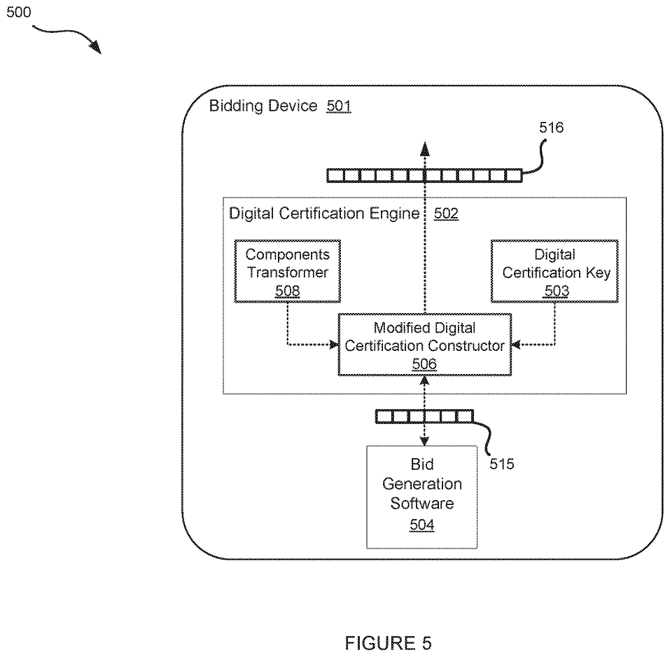

FIG. 5 depicts a bidder-side system 500 configured to transmit a modified digital certificate for processing and authentication as described above. Bidder-side system 500 includes a bidding device 501, upon which is installed a digital certification engine 502. Digital certification engine 502 receives bid components 515, here depicted as an array of values, from bid generation software 504 also installed on bidding device 501.

Digital certification engine 502 includes a modified digital certification constructor 506 which consumes the received bid components 515. A components transformer 508 and a digital certification key 503 are retrieved based on bid generation software 504, and modified digital certification constructor 506 use both to apply a deterministically reproducible transformation to the received bid components 515 to yield a modified digital certificate 516 which is output to either bidding device 501 or further downstream processes on bidding device 501 or remote, such as bid orchestrator 406 described above in reference to FIG. 4. Moreover, the applied transformation is understood to be reproducible with a privately held key or decoder, retrievable by downstream processors.

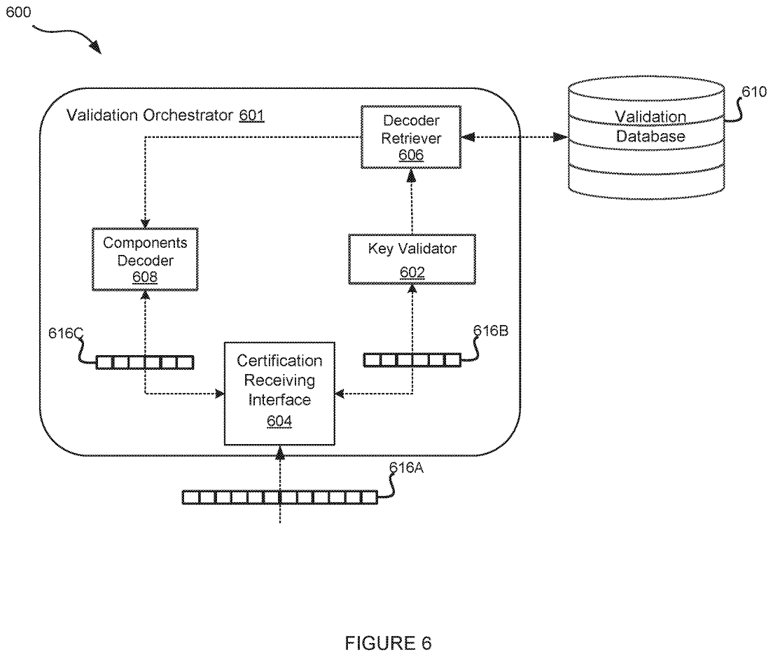

FIG. 6 depicts a validator-side system 600 configured to receive and process a modified digital certification as described above. Validator-side system 600 includes a validation orchestrator 601, which may be hosted on a server as, for example, one of digital certification services 255 described above. Validation orchestrator 601 includes a certification receiving interface 604 which is configured to receive a modified digital certificate 616A, such as that produced by bidder-side system 500 described above and depicted here as a vector or array of values. Certification receiving interface 604 extracts a digital certificate indicator 616B from modified digital certificate 616A and validates the key using a key validator 602. Key validator 602 may transform the extracted digital certificate indicator 616B to a predicted unmodified digital certificate and use it to identify an appropriate decoder to apply to modified digital certificate 616A and compare to the original unmodified digital certificate to ensure confirm that the correct decoder was applied.

Decoder retriever 606 retrieves the appropriate decoder and/or comparison values from validation database 610. This data is then passed, in whole or in part, to a components decoder 608. Components decoder 608 applies the retrieved decoder to a components sub-array 616C extracted from modified digital certificate 616A to yield predicted approximate components. Certification receiving interface 604 then compares the predicted approximate components to submitted components to determine a likelihood of the authenticity of the submitted components.

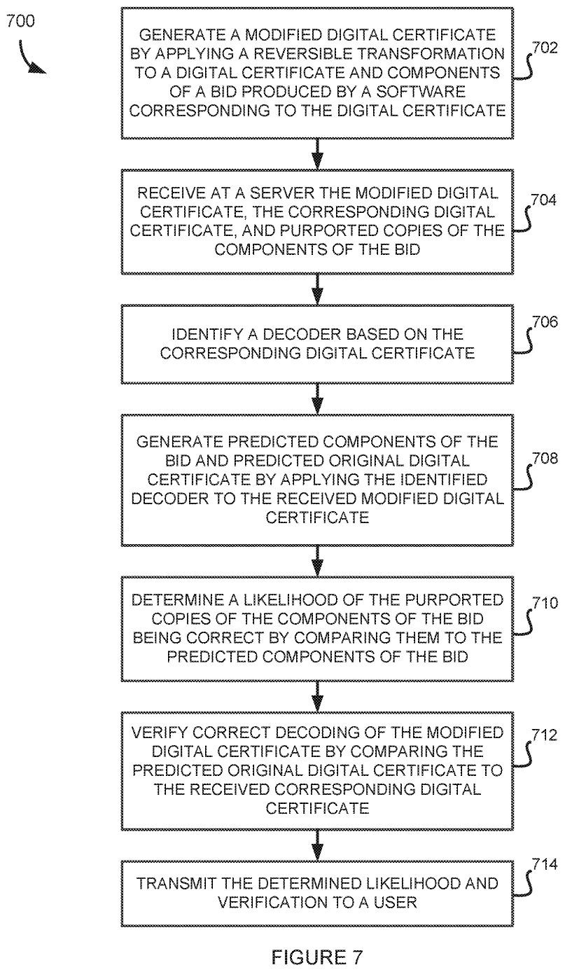

FIG. 7 is a flowchart of a digital certification method 700. Digital certification method 700 can be performed by various devices and across various architectures, including those of the aforementioned examples described above. Digital certification method 700 begins at step 702, where a computing device may generate a modified digital certificate by applying a reversible transformation to a digital certificate and components of a bid produced by a software corresponding to the digital certificate.

At step 704, a server may receive the modified digital certificate, the corresponding digital certificate, and purported copies of the components of the bid.

At step 706, the server or another computing device may identify a decoder based on the corresponding digital certificate.

At step 708, the server or another computing device may generate predicted components of the bid and a predicted original digital certificate by applying the identified decoder to the received modified digital certificate.

At step 710, the server or another computing device, may determine a likelihood of the purported copies of the components of the bid being correct by comparing them to the predicted components of the bid.

At step 712, the server or another computing device may verify the correct decoding of the modified digital certificate by comparing the predicted original digital certificate to the received corresponding digital certificate.

At step 714, the server or another computing device may transmit the determined likelihood and verification to a user.

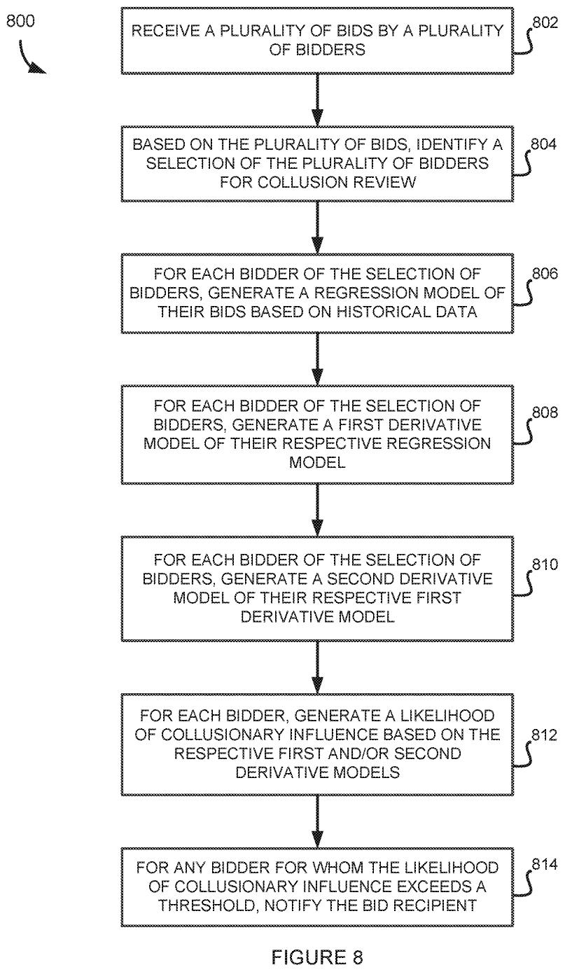

FIG. 8 is a flowchart of a collusion detection method 800. Collusion detection method 800 can be performed by various devices and across various architectures, including some of those of the aforementioned examples described above. Collusion detection method 800 begins at step 802, where a computing device may receive a plurality of bids by a plurality of bidders.

At step 804, a computing device may identify a selection of the plurality of bidders for collusion review based on the plurality of bids.

At step 806, a computing device may, for each bidder of the selection of bidders, generate a regression model of their bids based on historical data.

At step 808, a computing device may, for each bidder of the selection of bidders, generate a first derivative model of their respective regression model.

At step 810, a computing device may, for each bidder of the selection of bidders, generate a second derivative model of their respective first derivative model.

At step 812, a computing device may, for each bidder, generate a likelihood of collusionary influence based on the respective first and/or second derivative models.

At step 814, a computing device may, for any bidder for whom the likelihood of collusionary influence exceeds a threshold, notify the bid recipient.

The illustrations of the examples described herein are intended to provide a general understanding of the structure of the various embodiments. The illustrations are not intended to fully describe all the elements and features of the disclosure described herein. Many other examples may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive. Any subsequent arrangement designed to achieve the same or similar purpose may be substituted for the specific examples shown. This disclosure is intended to cover all subsequent adaptations or variations of various embodiments. The appended claims are intended to cover all such modifications, enhancements, and other embodiments which fall within the scope of the present disclosure. Thus, to the maximum extent allowed by law, the scope of the present disclosure is to be determined by the broadest permissible interpretation of the following claims and their equivalents and shall not be restricted or limited by the foregoing detailed description.

While the invention is described through the above-described exemplary embodiments, modifications to, and variations of, the illustrated embodiments may be made without departing from the inventive concepts disclosed herein. For example, although specific parameter values, such as materials and dimensions, may be recited in relation to disclosed embodiments, within the scope of the invention, the values of all parameters may vary over wide ranges to suit different applications. Unless otherwise indicated in context, or would be understood by one of ordinary skill in the art, terms such as “about” mean within ±20%.

As used herein, including in the claims, the term “and/or,” used in connection with a list of items or categories, means one or more of the items or categories in the list, i.e., at least one of the items or categories in the list, but not necessarily all the items in the list and not necessarily one item from each category in the list. As used herein, including in the claims, the term “or,” used in connection with a list of items or categories, means one or more of the items or categories in the list, i.e., at least one of the items or categories in the list, but not necessarily all the items in the list and not necessarily one item from each category in the list. “Or” does not mean “exclusive or,” and “or” does not mean “at least one from each (category).”

As used herein, including in the claims, an element described as being configured to perform an operation “or” another operation is met by an element that is configured to perform only one of the two operations. That is, the element need not be configured to operate in one mode in which the element performs one of the operations, and in another mode in which the element performs the other operation. The element may, however, but need not, be configured to perform more than one of the operations.

Although aspects of embodiments may be described with reference to flowcharts and/or block diagrams, functions, operations, decisions, etc. of all or a portion of each block, or a combination of blocks, may be combined, separated into separate operations or performed in other orders. References to a “module,” “operation,” “step” and similar terms are for convenience and not intended to limit their implementation. All or a portion of each block, module, operation, step or combination thereof may be implemented as computer program instructions (such as software), hardware (such as combinatorial logic, Application Specific Integrated Circuits (ASICs), Field-Programmable Gate Arrays (FPGAs), processor or other hardware), firmware or combinations thereof.

The electronic algorithmic bid item generator, electronic bid item validator, project server, transmitting device, digital certification engine, bid generation software, validation server, decoder, additional server, etc. or portions thereof may be implemented by one or more suitable processors executing, or controlled by, instructions stored in a memory. Each processor may be a general-purpose processor, such as a central processing unit (CPU), a graphic processing unit (GPU), digital signal processor (DSP), a special purpose processor, etc., as appropriate, or combination thereof.

The memory may be random access memory (RAM), read-only memory (ROM), non-volatile memory (NVM), non-volatile random-access memory (NVRAM), flash memory or any other memory, or combination thereof, suitable for storing control software or other instructions and data. Instructions defining the functions of the present invention may be delivered to a processor in many forms, including, but not limited to, information permanently stored on tangible non-transitory non-writable storage media (e.g., read-only memory devices within a computer, such as ROM, or devices readable by a computer I/O attachment, such as CD-ROM or DVD disks), information alterably stored on tangible non-transitory writable storage media (e.g., floppy disks, removable flash memory and hard drives) or information conveyed to a computer through a communication medium, including wired or wireless computer networks. Moreover, while embodiments may be described in connection with various illustrative data structures, database schemas and the like, systems may be embodied using a variety of data structures, schemas, etc.

Disclosed aspects, or portions thereof, may be combined in ways not listed herein and/or not explicitly claimed. In addition, embodiments disclosed herein may be suitably practiced, absent any element that is not specifically disclosed herein. Accordingly, the invention should not be viewed as being limited to the disclosed embodiments.

What is claimed is:

1. A system for automatically detecting use by multiple parties of same or similar electronic algorithmic bid item generator, the system comprising:
at least one electronic algorithmic bid item generator configured to automatically:
receive a request for a bid item, the request identifying a bid component;
in response to receipt of the request, automatically generate the bid item, the bid item including a price and an identification of the bid component;
for each such bid item, generate an associated digital certificate; and
output the bid item and its associated digital certificate;
an electronic bid item validator configured to automatically:
receive, directly and/or indirectly from the electronic algorithmic bid item generator, a plurality of received bid items and their associated digital certificates;
for each received bid item, analyze the digital certificate of the bid item for an indication the bid item does not meet predetermined criteria related to bid item generation; and
for each received bid item, if the analysis finds the indication, reject the received bid item, otherwise pass the received bid item.

2. The system of claim 1, wherein:
the at least one electronic algorithmic bid item generator is configured to automatically generate the bid item according to predefined rules and to generate the digital certificate such that the digital certificate indicates that the bid item was generated according to the predefined rules; and
the indication the bid item does not meet the predetermined criteria comprises lack of the indication that the bid item was generated according to the predefined rules in the digital certificate.

3. The system of claim 2, wherein the predefined rules are configured to prevent tacit collusion among multiple bidders.

4. The system of claim 3, wherein:
the at least one electronic algorithmic bid item generator is configured to receive the request for the bid item from a bidder; and
the predefined rules are configured to prevent the at least one electronic algorithmic bid item generator using bid data aggregated from multiple other bidders.

5. The system of claim 3, wherein:
the at least one electronic algorithmic bid item generator is configured to:
receive the request for the bid item from a bidder; and
generate the bid item by utilizing a bidder-specific model associated with the bidder; and
the predefined rules are configured to prevent utilization of the bidder-specific model in generating a bid item for any other bidder.

6. The system of claim 3, wherein the predefined rules are configured to prevent the at least one electronic algorithmic bid item generator using competitor bid data in generating the bid item.

7. The system of claim 2, wherein:
the at least one electronic algorithmic bid item generator is configured to receive the request for the bid item from a bidder; and
the predefined rules are configured to prevent generating a bid item based on a bid item prediction for another bidder.

8. The system of claim 1, wherein the at least one electronic algorithmic bid item generator is configured to:
receive the request for the bid item from a bidder; and
constrain the bid item price as a function of historic costs of the bidder.

9. The system of claim 1, wherein the at least one electronic algorithmic bid item generator is configured to:
receive the request for the bid item from a bidder;
receive at least one bidder-specific cost of the bidder, in association with the request for the bid item; and
constrain the bid item price as a function of the at least one bidder-specific cost of the bidder.

10. The system of claim 1, wherein:
the digital certificate includes provenance information about the bid item; and
the indication the bid item does not meet the predetermined criteria comprises the provenance information indicating a predetermined unacceptable provenance.

11. The system of claim 10, wherein the unacceptable provenance comprises machine-generated and subsequently modified.

12. The system of claim 10, wherein the unacceptable provenance comprises human-entered.

13. The system of claim 1, wherein:
the at least one electronic algorithmic bid item generator is configured to automatically generate the digital certificate such that the digital certificate includes identifications of information and/or methods used by the electronic algorithmic bid generator in generating the bid item; and
the electronic bid item validator is configured to automatically:
identify, among the plurality of received bid items, bid items that identify comparable bid components, thereby identifying a group of comparable bid items; and
for each received bid item of each group of comparable bid items, analyze the digital certificate of the bid item, in relation to digital certificates of other bid items of the group of comparable bid items, for the indication the bid item does not meet the predetermined criteria;
wherein the indication the bid item does not meet the predetermined criteria comprises similarity of: (a) the information used by the at least one electronic algorithmic bid generator in generating the bid item to (b) information used by the same or a different electronic algorithmic bid generator in generating another bid item of the group of comparable bid items.

14. The system of claim 13, wherein the similarity comprises: a value in the information used by the at least one electronic algorithmic bid generator being within a predetermined range of a value of a comparable value in the information used by the same or a different electronic algorithmic bid generator.

15. The system of claim 13, wherein the similarity comprises: (a) identical methods used by the electronic algorithmic bid generator and the same or a different electronic algorithmic bid generator in generating the bid item and (b) a value in the information used by the at least one electronic algorithmic bid generator being within a predetermined range of a value of a comparable value in the information used by the same or a different electronic algorithmic bid generator.

16. The system of claim 13, wherein:
the digital certificate includes provenance information about the bid item; and
the indication the bid item does not meet the predetermined criteria comprises the provenance information indicating a predetermined unacceptable provenance.

17. A system for digitally certifying contributions to a construction project bid, the system comprising:
a project server orchestrating a bidding process for a construction project;
a transmitting device comprising a digital certification engine and a bid generation software; and
a validation server communicatively linked to a validation database storing (a) an identifier of a software configured to generate components of a construction project bid, (b) a digital certificate uniquely corresponding to the identifier, and (c) a decoder, the validation server configured to access a modified digital certificate generated by the transmitting device; wherein:
the digital certification engine generates the modified digital certificate comprising the digital certificate and a transformation applied to the generated components;
the decoder ingests one or more of the modified digital certificate, the identifier, or the generated components and generates an output comprising an indication whether the components were produced by the software corresponding to the identifier; and
the validation server transmits the indication to the project server.

18. The system of claim 17, wherein the indication comprises a binary value, one mode of the binary value affirming the components were produced by the software corresponding to the identifier and the other mode of the binary value denoting the values were not produced by the software corresponding to the identifier.

19. The system of claim 17, wherein the indication comprises a probabilistic value denoting a likelihood of the components having been produced by the software corresponding to the identifier.

20. The system of claim 17, wherein the indication comprises a unitary value denote either the components were produced or the components were not produced by the software corresponding to the identifier.

21. The system of claim 17, wherein the digital certification engine integrates multiple digital certificates and multiple respective components for multiple software into the modified digital certificate.

22. The system of claim 17, wherein the digital certification engine generates the modified digital certificate by applying a public-private key-based reversible hash to the generated components.

23. The system of claim 22, wherein the decoder comprises a private key corresponding to the digital certificate and generates the output by combining the public-private key-based reversible hash as applied to the generated components with the private key.

24. The system of claim 22, wherein the decoder comprises a private hash reversal algorithm corresponding to one or more of the digital certificate or the identifier.

25. The system of claim 17, wherein the decoder is stored at least in part on an additional server and the validation server retrieves the decoder from the additional server.

26. The system of claim 17, wherein the bid generation software and the digital certification engine are integrated with each other into a single software application.

27. The system of claim 17, wherein the bid generation software and the digital certification engine are separate software applications, the outputs of which are separably transmitted to one or more of the project server or the validation server.

28. A system for detecting collusion in project bidding, the system comprising:
a server communicatively linked to a project coordinator, the project coordinator configured to receive a plurality of bids for a corresponding project and provide the plurality of bids to the server;
a bid repository of historical bid data associated with a portion of bidders respectively associated with the plurality of bids;
a bidder cost repository of historical cost information associated with the portion of bidders; and
a context repository of one or more of historical economic context data or historical environmental data corresponding to shared time windows of the historical bid data;
wherein the server comprises:
an initial collusion detector configured to determine a selection of bidders from the plurality of bidders for collusion review;
a bidder model generator configured to generate respective regression models of the portion of bidders based on data from one or more of the bid repository, the bidder cost repository, or the context repository; and
a collusionary influence detector configured to generate a likelihood of collusionary influence based on the generated regression models;
wherein the server sends the project coordinator a notice when the likelihood of collusionary influence for a corresponding bidder of the portion of bidders exceeds a threshold, the notice comprising an indication of the respective likelihood and an identification of the corresponding bidder.

29. The system of claim 28, further comprising:
a derivative model generator configured to generate respective derivative models respectively extracted from each generated regression model;
wherein the collusionary influence detector generates the likelihood of collusionary influence based on the derivative models.

30. The system of claim 29, further comprising:
a secondary derivative model generator configured to generate second derivative models respectively from each generated derivative models;
wherein the collusionary influence detector generates the likelihood of collusionary influence based on the secondary derivative models.

31. The system of claim 28, wherein one or more of the bid repository, the bidder cost repository, or the context repository is stored on one or more additional servers respectively communicatively linked to the server.

32. The system of claim 28, wherein the indication of the respective likelihood is a binary value.

33. The system of claim 28, wherein the indication of the respective likelihood is a continuous value.

34. The system of claim 28, wherein the indication of the respective likelihood is a categorical value.

35. The system of claim 28, wherein the server further comprises:
a segmenting module configured to temporally group data from one or more of the bid repository, the bidder cost repository, or the context repository;
wherein the bidder model generator is further configured to generate the regression models based on one or more segment regressions associated with a respective bidder of the portion of bidders.

36. The system of claim 28, wherein the server is further configured to store a record of an alert in respective individual bidder history records of each corresponding bidder.
